(19) United States
(12) Patent Application Publication
(10) Pub. No.: US 2008/0095599 A1
(43) Pub. Date: Apr. 24, 2008

(54) Transfer Vehicle

(76) Inventor: Klaus Hahn, Mannheim (DE)

Correspondence Address: DEERE & COMPANY, ONE JOHN DEERE PLACE, MOLINE, IL, 61265, US

(21) Appl. No.: 11/851,541

(22) Filed: Sep. 7, 2007

(30) Foreign Application Priority Data
Oct. 21, 2006 (DE) 10 2006 049 779.1

(51) Int. Cl. B60P 1/42; B60L 11/00; B65G 33/34; F16H 48/06

(52) U.S. Cl. 414/526; 198/657; 318/12; 475/149

(57) ABSTRACT

A transfer vehicle is pulled by a towing vehicle. The transfer vehicle comprises a container and an unloading conveyor. The container serves to receive bulk goods. The unloading conveyor serves to unload the bulk goods located in the container. In order to allow a simple technical construction and a variable drive of the unloading conveyor, an electrical drive is coupled to the unloading conveyor and serves exclusively for driving the unloading conveyor.

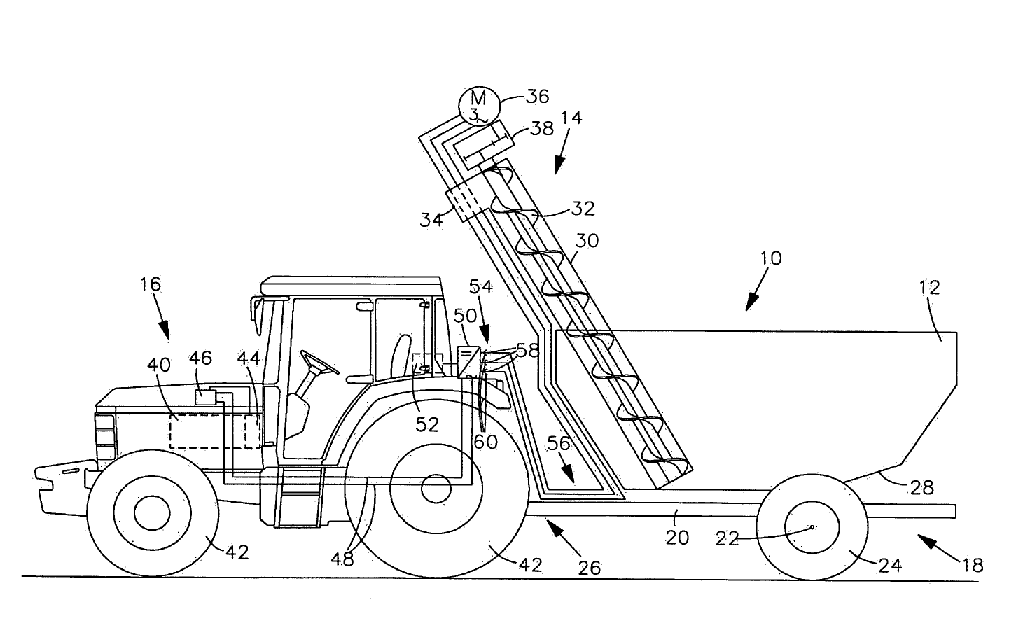

### FIELD OF THE INVENTION

The invention relates to a transfer vehicle pulled by a vehicle. The transfer vehicle comprises a container and an unloading conveyor. The container serves to receive bulk goods, in particular biomass. The unloading conveyor serves to unload the bulk goods located in the container.

### BACKGROUND OF THE INVENTION

Such transfer vehicles are used in agriculture for conveying high-value bulk goods, such as for example grain or mineral fertilizer, in particular in arable farming.

The conventional harvest time for combine-harvested crops has been reduced from almost two months to only a few weeks. This was able to be carried out with more powerful harvesting machines which, however, as a result also became more expensive. Thus, during harvesting, every minute of stoppage is associated with high financial costs. Accordingly, many attempts have been made to shorten the harvest time further or fully utilize the harvest time.

In order to avoid stoppage times of the combine harvester, the storage containers thereof during threshing are emptied into a specific agricultural trailer driven alongside and pulled by a tractor, namely a so-called transfer vehicle. Said transfer vehicles then drive to the edge of the field and, in turn, empty the grain into a large-volume non-agricultural transport vehicle waiting on the road. In this connection, transfer times of approximately 2 minutes are achieved for a container content of 20 m³.

The transfer vehicles generally comprise a container and/or receiving container of substantially prismatic shape and a one-part or two-part emptying device and/or unloading conveyor which are both constructed on a single-axle or multi-axle chassis. The chassis has a frame to which a continuous axle is attached with a right and a left running wheel on the outer sides of the frame and which comprises a tow hook which is designed to be attached to a tractive machine, generally a tractor. The running wheels are accordingly adapted to driving over uneven ground. The bottom wall of the container thus extends over the entire length of the receiving container in a funnel-shaped manner towards the vehicle longitudinal axis. In an unloading conveyor of two-part configuration, a first part is arranged as an internal conveyor worm (feed worm) inside and in the lower region of the receiving container, and accordingly aligned with the vehicle longitudinal axis. In the region of the front end wall of the receiving container, the inner conveyor worm is coupled to an outer conveyor worm (delivery worm), which forms a second part of the two-part unloading conveyor. The outer conveyor worm is arranged in a tubular housing and/or in a conveying pipe and faces obliquely upwards and comprises an open end. The length and the angle of inclination of the second part of the unloading conveyor is accordingly designed for transferring to a large-volume transport vehicle. By a rotary motion at constant or variable speed of both the inner and the outer conveyor worm, grain and/or bulk goods in the receiving container are conveyed in the direction of the rotating conveyor worm, dictated by the diameter thereof and pitch of the worm.

Transfer vehicles with high conveying capacity have, due to the large worm diameter, a correspondingly high dead weight. The dead weight and the weight of the grain to be received thus form limits within which a useful application on the field is still possible. The greater and heavier such transfer vehicles are designed to be, the more difficult it is for said transfer vehicles to be transported over fields, particularly in the loaded state. Thus the capacity of conventional transfer vehicles may hardly be increased further. The conveying capacity is, however, not only limited by the worm diameter and thus the weight of the conveyor worm but also by the speed thereof. An increase in the speed of the conveyor worm results in a higher load of the grain to be conveyed and may result in damage to the cereal grains on the worm. Thus losses associated with the quality of the harvest may be foreseen. Additionally, the structural and manufacturing cost is correspondingly high, in order to ensure running of the heavy conveyor worms in a manner which is low in vibration.

The transfer vehicles are not only used for the harvest, but also during sowing and fertilizing for filling the appropriate machines, which all have an extremely small storage container. Filling with fertilizer and seed is even more dependent on emptying the transfer vehicle in a manner which does not cause damage.

Conventional transfer vehicles pulled by a tractive vehicle or tractor are driven purely mechanically. In this connection, the mechanical drive of the unloading conveyor is carried out via the power take-off shaft of the tractor. This requires a relatively complicated construction. Large step-down ratios are necessary which, in particular with the relatively frequently occurring torque impulses, are particularly critical and generally require overload clutches. The speed of the conveyor worm of the unloading conveyor is at a fixed ratio with the speed of the power take-off shaft of the tractor and may only be adapted in a restricted manner to the respective conditions. In order not to overload the coupling shaft between the power take-off shaft and the mechanical drive of the transfer vehicle, the drive sometimes has to be switched off when driving around corners. This leads to high loads when starting up the unloading conveyor again, which sometimes even makes starting up again impossible.

The object underlying the invention is regarded as configuring a transfer vehicle of the aforementioned type such that the aforementioned problems are overcome.

### SUMMARY OF THE INVENTION

According to the present invention, there is provided a transfer vehicle including an unloading conveyor having a variable drive of a simple technical construction intended to operate both in a stationary mode and in a loading and transport mode.

An object of the invention is to provide a transfer vehicle of the aforementioned type which is equipped with an unloading conveyor that is selectively driven by a variable speed drive that is dedicated to the unloading conveyor.

This object is achieved by providing a transfer vehicle equipped with an unloading conveyor, with an electrical drive being associated with the unloading conveyor, by means of which the unloading conveyor is exclusively driven.

In this connection, the transfer vehicle may be pulled by a vehicle, for example by a farm tractor. In principle, it is also conceivable, but not preferred, to configure the transfer vehicle as a self-propelling vehicle, which in this connection almost exclusively carries out the functions of a transfer vehicle. In a self-propelled transfer vehicle, electric motors (for example single wheel drive motors) could also be used for the travel drive.

A generator or electrical energy accumulator (battery, supercap, flywheel storage, etc.) which may be mounted on the tractive vehicle or the self-propelling vehicle and may be driven by an internal combustion engine is considered as an electrical energy source, for example, which may be mounted on the tractive vehicle or the transfer vehicle, or a stationary electrical power supply with a power outlet is considered. Stationary operation without a tractive vehicle is possible at a power outlet.

The transfer vehicle according to the invention has a series of advantages: by the elimination of a mechanical drive no coupling shafts are now required with their aforementioned drawbacks (force transmission when driving around corners). By the elimination of a coupling shaft, the coupling process between the tractive vehicle and the transfer vehicle may be accelerated and automated. Moreover, the elimination of the conventional drive shaft and the power divider results in a simple, space-saving construction in which the components may be arranged at a relatively low level. For example, as a result, the centre of gravity of the transfer vehicle may be lower than was previously conventional, larger containers may be used and/or a lower clearance height may be achieved. No bushing is required for the drive shaft through a container wall or an external conveyor worm with a corresponding opening for the container, which from a structural point of view leads to a further simplification.

It is particularly advantageous that the drive of the unloading conveyor is mechanically uncoupled from the internal combustion engine of the vehicle. As a result, the electrical drive may be driven steplessly and independently of the current speed of the internal combustion engine. For operating the unloading conveyor, generally a performance is sufficient which is produced at idling speed of the internal combustion engine of the vehicle. The unloading process is generally carried out in the state consisting of the pairing made up of the vehicle and transfer vehicle. Accordingly, for accelerating the unloading process with the transfer vehicle according to the invention, the speed of the internal combustion engine may possibly be slightly increased. It is, however, no longer necessary to increase substantially the speed of the internal combustion engine by using the accelerator pedal, which has caused unnecessary noise and has resulted in an increased consumption of fuel.

The electrical drive may thus generally be operated irrespective of the current speed of the internal combustion engine, with optimized efficiency. The electrical drive may be substantially integrated in the unloading conveyor, which allows a compact construction with components of modular construction. Due to the considerable reduction of shafts and linkages, the design according to the invention results in much fewer lubricating points than with known transfer vehicles, so that the maintenance cost is considerably reduced. The electrical drive may be adjusted steplessly in all operating conditions, it may be operated at a predetermined speed and the speed may be reversed. This applies in particular when the electrical energy of the electric motors is supplied by controllable frequency converters. When a plurality of electrical drives are provided, every drive may be switched on and off independently of the other drives. Transfer vehicles configured according to the invention allow, when operated with energy accumulators, driving with considerably reduced emissions (exhaust gases and noise).

The unloading conveyor could in the simplest case comprise a conveying pipe and a conveyor worm. As a result, a one-part unloading conveyor is formed. However, as mentioned above, a two-part unloading convey or could be provided. Such an unloading conveyor could comprise an internal conveyor worm which is arranged inside and in the lower region of the receiving container and is accordingly aligned with the vehicle longitudinal axis. In the region of the front end wall of the receiving container, the inner conveyor worm could be coupled to an outer conveyor worm. The inner conveyor worm could be driven by a first electric motor and the outer conveyor worm could be driven by a further electric motor. It is also conceivable to drive both conveyor worms with only one individual electric motor and an intermediate gear which is possibly provided.

Expediently, an asynchronous motor or a synchronous motor may be used as an electric drive. Said motors may be supplied by means of frequency converters. In contrast, asynchronous motors require less technical complexity and a lower financial cost. However, they have a lower power density and thus require a greater constructional space than synchronous motors.

According to a quite particularly preferred embodiment, the electrical drive is configured to be able to be operated steplessly. As a result, for example, a smooth start-up of the unloading conveyor and/or the conveyor worm may be advantageously implemented. By an electrical drive which may be controlled steplessly, a regulation of the speed of the conveyor worm is also possible, such that, for example, an unloading rate may be achieved which is as high as possible and/or at a maximum.

According to a preferred embodiment, the unloading conveyor may be operated reversibly. This may be implemented easily from a structural point of view by an electrical drive. A reversed operation of the unloading conveyor could, for example, be provided for cleaning purposes of the unloading conveyor and/or the conveyor worm.

A measuring device for measuring the electrical current consumed by the electrical drive is particularly preferably provided. As a result of the measured amperage, the torque may be detected at which the unloading conveyor is currently driven. In this regard, for example, overload protection of the electrical drive may be implemented in a simple and cost-effective manner. Thus, to this end, only the current torque at which the unloading conveyor is currently driven may be compared with a predetermined maximum torque and regulated such that the current torque is always under the predetermined maximum torque. In this regard, the harvested crops and/or bulk goods are not damaged during the unloading process—as indicated above.

According to a quite particularly preferred embodiment of the present invention, the electrical drive is controlled and/or regulated such that an unloading rate which is maximized or as high as possible during the unloading process of the transfer vehicle may be achieved. A maximized unloading rate could be present when, for example, the unloading conveyor is operated at a torque and/or a capacity which is under a predetermined maximum torque and/or a predetermined maximum capacity. Accordingly, an unloading of the harvested crops may advantageously be carried out in a reduced time, so that in an ideal situation there is only a short stoppage time or no stoppage time at all of the harvesting vehicle.

An alternative or additional control and/or regulating strategy of the electrical drive of the transfer vehicle could provide that with the generation of the electrical energy and/or when operating the electrical drive, an efficiency which is maximized and/or as high as possible may be achieved. Due to the present design of the transfer vehicle according to the invention there is advantageously no rigid and/or mechanical coupling between a diesel engine of a tractor, the speed of the power take-off shaft and thus a mechanical drive of the unloading conveyor. Instead, the diesel engine of the tractor may be operated at an operating point which has a lower speed at a higher load, namely for example the load of the generator to be driven by the diesel engine for producing the electric current for the electrical drive. In this regard, the fuel consumption may be advantageously reduced. The noise pollution for the immediate vicinity which is caused by a high speed of the diesel engine during the unloading process with a conventional transfer vehicle, may be reduced.

For speed and torque conversion, the electrical drive according to a preferred embodiment of the invention contains an electric motor with a downstream gear system, in particular a planetary gear system or step-down gear system. The gear system may be incorporated into a unit consisting of an electric motor, gear system and unloading conveyor. The gear system is preferably configured as a step-down gear system, so that the electric motor may be operated within an advantageous speed range.

Preferably, at least one frequency converter is provided. In particular a rectifier unit may rectify the three-phase alternating current of a power supply, whilst an inverter unit downstream of the rectifier unit carries out a frequency conversion for asynchronous motors or synchronous motors. Whilst the current is supplied, for example, by a generator arranged on the tractive vehicle, the inverter unit is located on the tractive vehicle or on the transfer vehicle. When using a stationary alternating current system, the rectifier unit may either be arranged on the transfer vehicle itself or also be arranged in a stationary manner. Thus the transfer vehicle and/or a vehicle pulling the transfer vehicle could comprise at least one rectifier unit and/or one inverter unit.

Different possibilities are advantageously available to embody and develop the teaching of the present invention. To this end, on the one hand, reference is made to the patent claims subordinate to Claim 1 and, on the other hand, to the subsequent explanation of the preferred embodiment of the invention with reference to the drawings. In connection with the explanation of the preferred embodiment of the invention with reference to the drawings, generally preferred embodiments and developments of the teaching are also explained.

### BRIEF DESCRIPTION OF THE DRAWINGS

The sole figure of the drawing is a schematic representation of an embodiment of a transfer vehicle according to the invention which is pulled by a towing vehicle.

### DESCRIPTION OF THE PREFERRED EMBODIMENT

In the only figure, a transfer vehicle 10 is shown which comprises a container 12 for receiving bulk goods. Moreover, the transfer vehicle 10 comprises an unloading conveyor 14 for unloading the bulk goods (not shown) located in the container. The transfer vehicle 10 is coupled to a towing vehicle shown here as a tractor 16 and may be pulled thereby.

The transfer vehicle 10 comprises a container 12 of substantially prismatic configuration. The container 12 and the unloading conveyor 14 are constructed on a single-axle chassis 18. The chassis 18 comprises a frame 20 on which a continuous axle 22 having opposite ends respectively provided with a right and a left running wheel of which only the left wheel 24 is shown. The frame 20 comprises a towbar 26, only indicated schematically, which is designed for being attached to the tractor 16. It is only indicated schematically that the bottom wall 28 of the container 12 therefore extends over the entire length of the receiving container 12 in a funnel-shaped manner towards the longitudinal axis of the vehicle. The unloading conveyor 14 is configured in one piece and comprises a conveyor worm 32 rotatably arranged in a conveying pipe 30 disposed about the longitudinal axis of the worm. The conveying pipe 30 comprises an open end 34 from which the harvested crops in the container 12 conveyed upwards by the conveyor worm 32 may be discharged. The length and the angle of inclination of the conveying pipe 30 is accordingly designed for transferring to a large-volume transport vehicle. The angle of inclination of the conveying pipe 30 relative to the vertical and/or horizontal may be variably adjusted. By a rotary movement at constant or variable speed of the conveyor worm 32, grain and/or biomass located in the receiving container 12 is delivered to the open end 34 by the rotating conveyor worm 32.

In a manner according to the invention, an electrical drive 36 is coupled for driving the conveyor worm 32. The unloading conveyor 14 and accordingly the conveyor worm 32 are exclusively driven by the electrical drive 36.

The electrical drive 36 comprises an asynchronous motor and is configured to be able to be operated steplessly. The electrical drive 36 may be driven in two opposing rotational directions depending on the control thereof. One of the rotational directions allows the emptying of the container 12. The opposing rotational direction may be used for cleaning purposes. Between the electrical drive 36 and the conveyor worm 32 a step down gear system 38 is provided, by which the relatively high speed of the electrical drive 36 may be reduced to a lower speed of the conveyor worm 32. The electrical drive 36, the step-down gear system 38 as well as the conveying pipe 30, together with the conveyor worm 32 may be mounted as a preassembled unit and/or assembly on the transfer vehicle 10. In the embodiment according to the only figure, the electrical drive 36 is arranged on the open end 34 of the conveying pipe 30. The electrical drive 36 together with the step-down gear system 38 could, however, also be arranged in a lower region of the transfer vehicle 10. The tractor 16 comprises an internal combustion engine 40, by which the wheels 42 of the tractor may be driven. A generator 44, also driven by the internal combustion engine 40, is provided which generates electrical current, in practice three-phase current. The three-phase current generated by the generator 44 is supplied to a rectifier unit 46 which converts the three-phase current into direct current and supplies a direct current link 48.

A converter 50 and/or an inverter unit is connected to the direct current link 48, by which the direct current of the direct current link 48 may be converted into three-phase current of a predetermined frequency. By means of the converter 50, the level of the current output at the electrical drive 36 and/or the rotational direction of the electrical drive 36 may also be set. To this end, a control device 52 is provided by means of which the converter 50 may be controlled. The converter 50 comprises a measuring device, not shown, by means of which the level of the electrical current output at the electrical drive 36 may be measured. The resulting measurement is supplied to the control device 52. As a result of the measured amperage, the torque may be detected at which the unloading conveyor 14 is currently driven. Thus the control unit 52 may operate the converter 50 and thus the electrical drive 36 such that, on the one hand, the unloading conveyor 14 may achieve a maximized unloading rate. On the other hand, the electrical drive 36 as well as the components of the unloading conveyor 14 may be protected from overload, if torque peaks or blockages occur during the unloading process of the transfer vehicle 10, by for example less current or no current being made available, for example, to the electrical drive 36 or by the conveyor worm 32 being reversed in order to eliminate the blockage.

A schematically indicated plug connection 54 may reversibly connect the leads 56 between the plug 58 of the transfer vehicle 10 and the electrical drive 36 and the socket 60 of the tractor 16. Between the tractor 16 and the transfer vehicle 10 no mechanical torque transmission is therefore required between a power take-off shaft of the tractor 16 and the unloading conveyor 14. Although, in this embodiment, the converter 50 is arranged on the tractor 16, it might also be conceivable to arrange the converter 50 on the transfer vehicle 10.

It is particularly preferred that the electrical drive 36 is controlled and/or regulated such that with the generation of the electrical energy and when operating the electrical drive 36 a maximized efficiency of the pairing made up of the transfer vehicle 10 and tractor 16 may be achieved.

Having described the preferred embodiment, it will become apparent that various modifications can be made without departing from the scope of the invention as defined in the accompanying claims.

1. A transfer vehicle pulled by a towing vehicle and including a container and an unloading conveyor, with the container serving to receive bulk goods and the unloading conveyor being coupled to an interior of said container and serving to unload the bulk goods located in the container and a conveyor drive being coupled for driving said conveyor: the improvement comprising: said conveyor drive being an electrical drive by means of which the unloading conveyor is exclusively driven.

2. The transfer vehicle, as defined in claim 1, wherein said unloading conveyor comprises a conveying pipe containing a conveyor worm to which said electrical drive is coupled.

3. The transfer vehicle, as defined in claim 1, wherein said electrical drive comprises one of an asynchronous motor or a synchronous motor.

4. The transfer vehicle, as defined in claim 3, wherein said motor is a stepless motor.

5. The transfer vehicle, as defined in claim 1, wherein said electrical drive is reversible.

6. The transfer vehicle, as defined in claim 1, wherein said electrical drive includes a measuring device for measuring the electrical current consumed by the electrical drive and for using the measured electrical current for deriving the torque at which the unloading conveyor is currently being driven.

7. The transfer vehicle, as defined in claim 1, wherein said electrical drive includes a control device operable for maximizing an unloading rate of said conveyor.

8. The transfer vehicle, as defined in claim 1, wherein said electrical drive includes a control device operable for maximizing the efficiency of the generation of electrical energy during the operation of said electrical drive.

9. The transfer vehicle, as defined in claim 1, wherein said electrical drive includes an electric motor coupled to a downstream gear system defining one of a planetary gear system or a step-down gear system.

10. The transfer vehicle, as defined in claim 1, wherein said electrical drive includes at least one frequency converter.

11. The transfer vehicle, as defined in claim 1, wherein said electrical drive includes at least one rectifier unit or one inverter unit.
